(19) United States
(12) Patent Application Publication
(10) Pub. No.: US 2011/0022499 A1
(43) Pub. Date: Jan. 27, 2011

(54) Personal mobile shopping network - a method of sales and retailing involving multimedia messaging feature of mobile cellular phones and PDA devices

(76) Inventor: Shakira Nida Hogan, Rahway, NJ (US)

Correspondence Address: SHAKIRA HOGAN, 1403 BARN HARDT LN, RAHWAY, NJ, 07065, US

(21) Appl. No.: 12/458,813

(22) Filed: Jul. 23, 2009

(51) Int. Cl. G06Q 30/00; G06Q 20/00; G06Q 50/00; H04W 4/00

(52) U.S. Cl. 705/27.2; 455/414.1

(57) ABSTRACT

The method and apparatus of the present invention relates to a method of selling merchandise, particularly clothing fashions and accessories, to customers via multimedia text messages through the customer's mobile cell phone device. Initially, potential customers will be directed to sign up to be placed on the network list, providing cell phone number, name, and address. Once the person is a registered member of the network it will be able to receive the multimedia message alerts of items that are available for sale. The alert will contain a picture of the item, short description of the item, retail price, sale price where applicable, and the multiple media options for transactions and purchase, as well as the website where the item is located for further viewing. This is a new method of retailing through the use of the mobile phone by which a personal shopper can do all the bargain shopping for the customer, through any and all media, from large and small manufacturers, independent designers, designers, department stores, specialty boutiques, and large chain stores. For any and all merchandise and commerce including electronics, apparel, sporting goods, home sales, hardware, and commodities and then send the picture of item or items with description and comparison cost to their consumer/client via their personal mobile phone or PDA device. If a customer is interested in purchasing merchandise, he/she may do so at the established online website, third party mobile transaction processor, or through the established company telephone number.

### CROSS SECTION TO RELATED APPLICATIONS

This application claims benefit of Provisional application number # 61134986071608

### DESCRIPTION

### Background of the Invention

1. Field of the Invention

This invention generally relates to a method of selling merchandise to a customer at a time convenient to the customer on demand. More specifically, the present invention relates to a method of selling clothing through the multimedia messaging feature in mobile phones and PDA devices, which one person can do all the work of finding the best deals, and conveniently sending them to the consumer's phone as the items become available enhancing the experience of comparison shopping for the customer, wherein the customer can send a text message of what it is that they are looking for, and be notified when it becomes available, as well as just wait for the alerts of items that become available, and are sent to them, wherein. Essentially, the present invention relates to a personal shopping service that drives directly to the customer's mobile cellular device.

2. Related Art

Conventionally, retail clothing stores have been located at fixed positions as a stand-alone store, or as part of a shopping center or mall or at some other location. As such, conventionally, customers travel to the stores to buy clothing. As such, a customer may browse through merchandise that is displayed and sales help may be provided for the customer. Further, customers can generally try on clothing in dressing rooms and then purchase the clothing at the store location. The customer is generally made aware of the location of the store through mass media advertising.

Other methods of retailing goods to customers are also known. For example, it is known to send catalogs to the homes of potential customers such that the potential customers can browse through the catalog, call up the store or the office from which the catalog was sent to place an order, and have the merchandise delivered via mail or another type of delivery service. However, this type of shopping experience has drawbacks, for example, the merchandising is not dynamic and not interactive, variations in body types are unaccounted for, the customer cannot try on the clothes prior to making a purchase, etc. Catalogs may also show designer fashions, and then substitute actual goods with affordable fabrics, which is why consumer may wonder why the picture and the actual item may not match.

A similar shopping experience can take place over the Internet wherein one uses an electronic catalog to browse through merchandise. However, as with traditional catalogs, there are limitations placed on transaction.

Another alternative merchandising method includes selling merchandise from a vehicle. Selling merchandise from a vehicle that is mobile and can move from place to place. Most merchandise sold from vehicles, either at flea markets or other locations, allows the customer to view the merchandise housed within the vehicle from the exterior of the vehicle. Accordingly, one does not enter the vehicle to view the merchandise. One very important problem with this type of shopping scheme is that one often cannot try on the merchandise prior to purchasing same.

It is also known for people to bring fashions from a store location to one's home or office to allow one to browse merchandise and/or try on and purchase the merchandise in a convenient, comfortable location. However, one drawback with such a shopping method is that it is difficult to transport a substantial of inventory for one to review prior to making purchasing decisions.

Accordingly, what is needed, and has not heretofore been developed, is a flexible merchandising method wherein a targeted customer can be contacted directly by their cellular mobile device, convenient to the customer, and is less invasive to a person's privacy. This method of retailing keeps up with the fast pace of technology, and the changing times where there are so many options for the best deal and not enough time to sift through all and find out what is best for you. What is also needed is the professional to provide expert style advice, on demand of the consumer and meet the retailing expectations of the increasingly rapid lifestyle lead by the evolving technological development of the world. This is necessary to be done on the consumer terms in the most common way to reach the target consumer, and that is through alerts to their personal mobile cellular device via the phones, multimedia messaging feature. This system of retailing is led by the professional personal shopper to oversee and monitor this process so that it will continue to maintain consistency in benefiting the consumers needs.

None of the previous efforts in this area, taken either alone or in combination, teach or suggest all of the benefits and the utility of the present invention.

### OBJECTS AND SUMMARY OF THE INVENTION

It is a primary object of the present invention to provide a method for selling merchandise to a customer that is convenient to the customer.

It is another object of the present invention to provide a method of selling merchandise to a customer which is mobile and keeps up with the pace of technology retailing that we are living in.

It is another object of the present invention which identifies target customers and then registers such customers in the database.

It is another object of the present invention to provide a method of selling merchandise to a customer which includes sending multimedia text message alerts to the cellular mobile device of the customer.

It is an additional object of the present invention to provide a method for selling merchandise to a customer that would require the item to be shipped to the customer following the purchase.

It is a further object of the present invention to provide a method of selling merchandise to a customer and providing fashion tips to customers on demand through multimedia messaging of the customer's mobile cellular device, allowing customers to browse through inventory alerts, and allowing customers to purchase merchandise through the various payment processing methods available to customers.

It is an additional object of the present invention to provide a network of merchandise contacts to the consumer/client to strengthen their fashion options.

It is even an additional object of the present invention to provide on demand advice wherein one can request purchasing advice directly from the professional personal shopper.

It is even an additional object of the present invention to provide transaction options wherein one can purchase clothing in any desired manner, i.e. with currency or with charge or credit cards.

The present invention achieves these objects with a method of selling merchandise, particularly clothing fashions and accessories, through the multimedia messaging feature in one's personal mobile cellular device. This is a new method of retailing by which a personal shopper does all the bargain shopping for the best deals on merchandise through any and all media, from large and small manufacturers, independent designers, designers, department stores, specialty boutiques, large chain stores. For any and all merchandise and commerce including electronics, apparel, sporting goods, home sales, hardware, commodities and then send the item or items with full picture, full description and comparison cost to their consumer/client via their multimedia messaging feature on their personal mobile phone or PDA device. The consumer is provided with multiple purchasing transaction options through a number set up by the personal shopping retailer by which he/she can then purchase the merchandise or the purchase can be made online by the consumer/client via the business corresponding website, or third party mobile sale processor. This retailing method system also includes options for networking, comparison pricing, and personal shopping via MMS messaging through mobile phones or PDA devices between large and small manufacturers, specialty boutiques, large chain retailers, independent designers, sample sale producers.

### BRIEF DESCRIPTION OF THE DRAWINGS

Other important objects and features of the invention will be apparent from the following Detailed Description of the Invention taken in connection with the accompanying drawings in which:

FIG. 1 shows an example of how the personal shopper captures 107 a picture of the merchandise 207 through the shopper's mobile phone or PDA device 207;

FIG. 2 shows an example 407 of what will be sent out to the client/consumer mobile phone 507 who is on the list;

FIG. 3 shows an example of how the client/consumer receives 307 the information sent by the personal shopper to his/her personal mobile phone and or PDA device 707;

FIG. 4 shows an example of the client/consumer receiving 807 the message through their mobile phone or PDA device;

FIG. 5 shows an example of how the message 701 appears and is received by the client/consumer;

FIG. 6 shows an example of how the client would place 702 an immediate order through their phone 703 for the item through the personal shoppers 800-number that is received at an established call center;

FIG. 7 shows an example of the option of consumer making the purchase from the personal shopper via the established website/shopping cart online 704 with a computer 705;

FIG. 8 shows an example of the Personal Shopper shipping 706 the requested item 707 to the consumer using one of the various existing shipping methods;

FIG. 9 shows an example of the consumer/client receiving the purchased item 708;

FIG. 10 shows an example of the consumer/client admiring 771 a successful and easy purchase 709;

FIG. 11 shows an example of how the picture item is issued to clients directly from the vendor/designer/retailer without the personal shopper physically capturing the image themselves. In this image a retailer multimedia messages the personal professional shopper a picture 776 of the item via mobile phone 776, and alerts 773 the professional shopper of the availability of the item 774 via mobile phone/PDA device 775.

FIG. 12 shows an example of the personal professional shopper receiving the alert 797 from the retailer/vendor/designer/seller, approving 778 the item for the client list and requesting 778 further information from the retailer/vendor/designer/seller via mobile phone 777.

FIG. 13 shows a flow chart of how the multimedia message, once composed and received in its entirety is sent directly from the mobile cellular device of the professional personal shopper to the client list and received. (client list is not limited to the sample amount that is shown in the illustration.

FIG. 14 shows a flow chart of consumer/client/customer behavior response to receiving the multimedia message alert of the shirt for sale. Client/customer/consumer's #2, #3, #4, #5, #6, #7, #9, #10, #11, #13 received the message, were not interested, and simply deleted the message, while client #2 purchased the item online at the company website, client #8 purchased the item directly through phone with a third party payment mobile processing company that uses the username and password of the client, and client #12, made the purchase with the professional personal shoppers customer service center (illustrative shipping and transaction acknowledgement relative the illustrated process featured in FIGS. 12, 13, and 14, can be referred back to FIGS. 7, 8, 9).

FIG. 15 shows an example of a client in need of assistance of making a wardrobe choice on their way home from work 717, and sends a multimedia message through her mobile cellular device 747 for advice to the professional personal shopping stylist.

FIG. 16 shows an example of the professional shopper receiving 177 the multimedia message through her mobile cellular device 727 in another location near a beach

FIG. 17 shows an example of the professional shopper replying 377, with advice to the client/consumer/customers fashion concerns using the multimedia feature of her mobile cellular device 277.

FIG. 18 shows an example of the client/consumer/customer receiving 677 the advice from the professional shopper stylist, through the multimedia messaging option on her mobile cellular device 577 in a separate location.

FIG. 19 shows an example of how the multimedia messages 77 are viewed on the screen of the mobile cellular device 7 when received through multimedia messaging. (this particular message does not include a picture as they do not always have to)

### DETAILED DESCRIPTION OF THE INVENTION

The present invention relates to a method for selling merchandise, particularly clothing and accessories, to customers, such as women and men, who are for whatever reason are not inclined of to go to stores at fixed locations and fixed hours. For example, career women have little time to travel to and from stores to shop, and most men would rather not have to go into a store to shop. Accordingly, the present invention brings the shopping experience to the customer at a time desirable for the customer in the privacy of the palm of his/her hand.

The method of selling merchandise to such women or men initially requires the identification of an appropriate customer. Typically, an appropriate customer is one with a busy life schedule such as a career person or a mother with children or one who has other obligations that take up a lot of time or a man who has other obligations that conflict with their need to shop. Accordingly, convenience is highly desired by such customers. These customers, once identified, are best informed of the method through direct telemarketing or recruitment through tradeshows, word of mouth, social networking online sites wherein the potential customer is contacted, the services provided are discussed, and hopefully, they agree to have their phone number registered in the database to receive multimedia messaging alerts wherein the present invention can begin to alleviate the stress and cost incurred from traditional shopping for the customer.

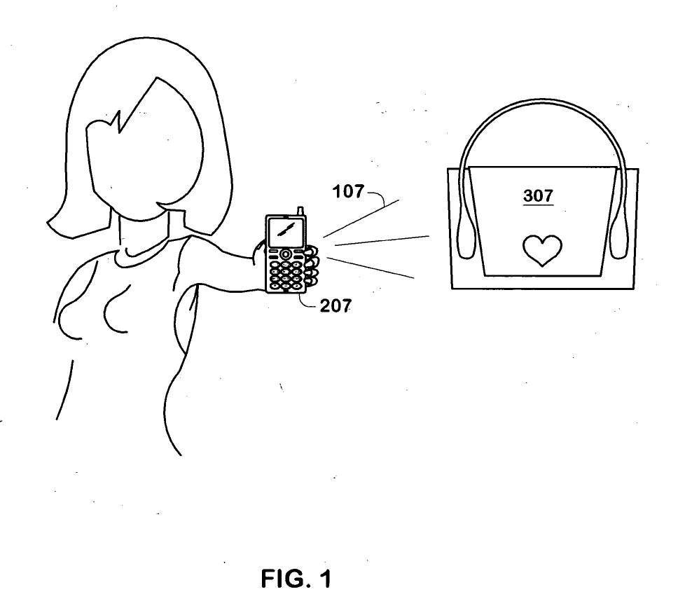

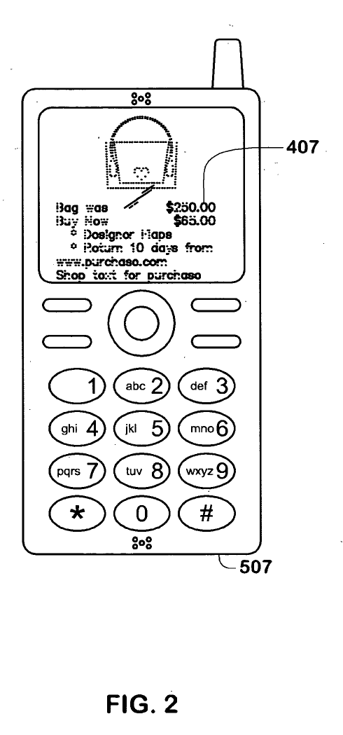

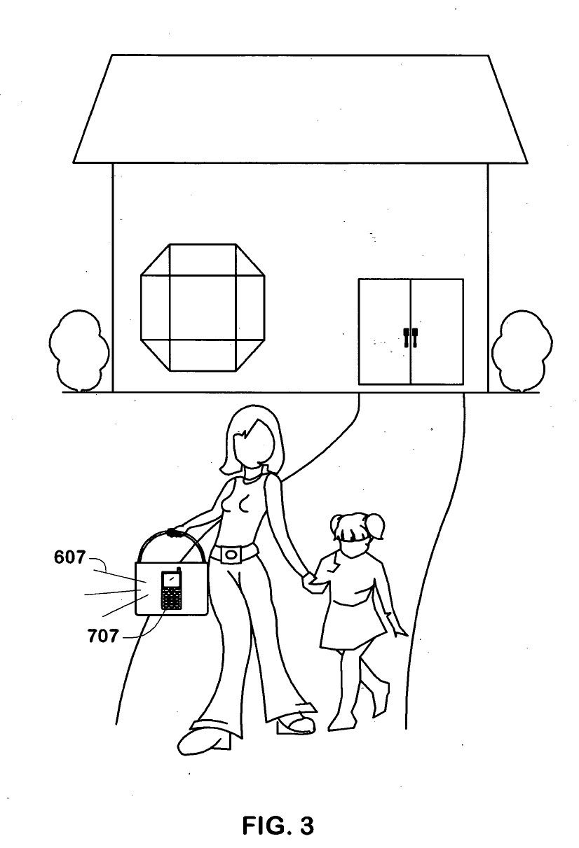

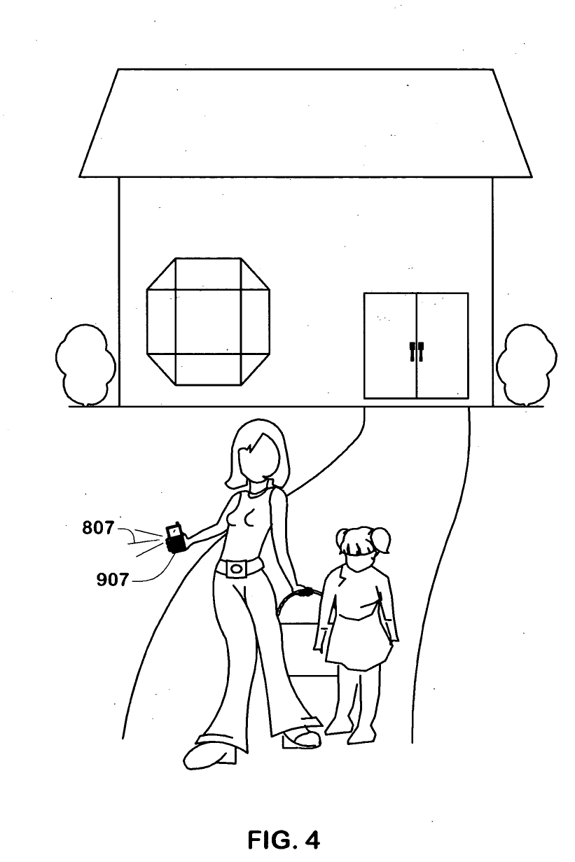

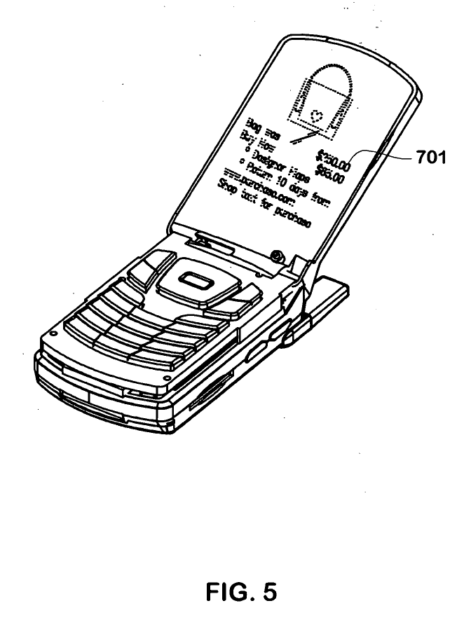

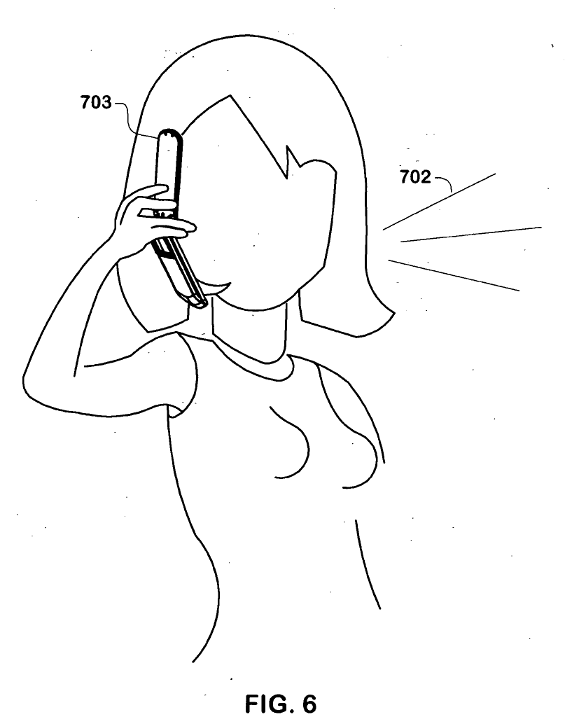

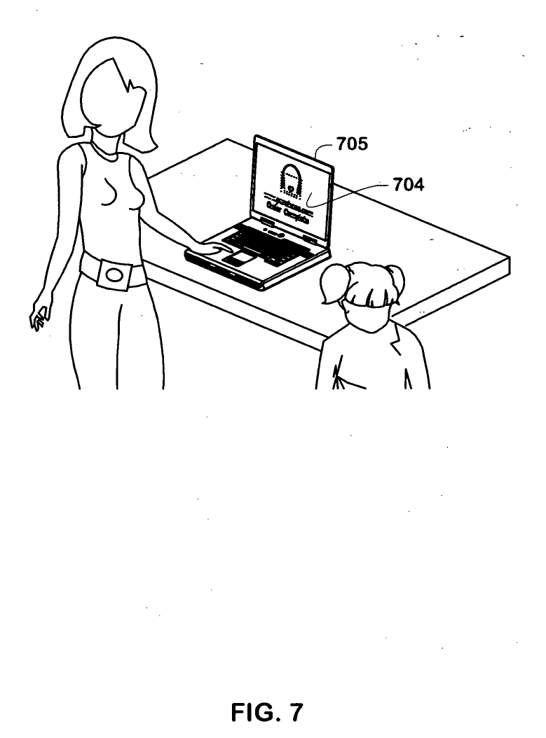

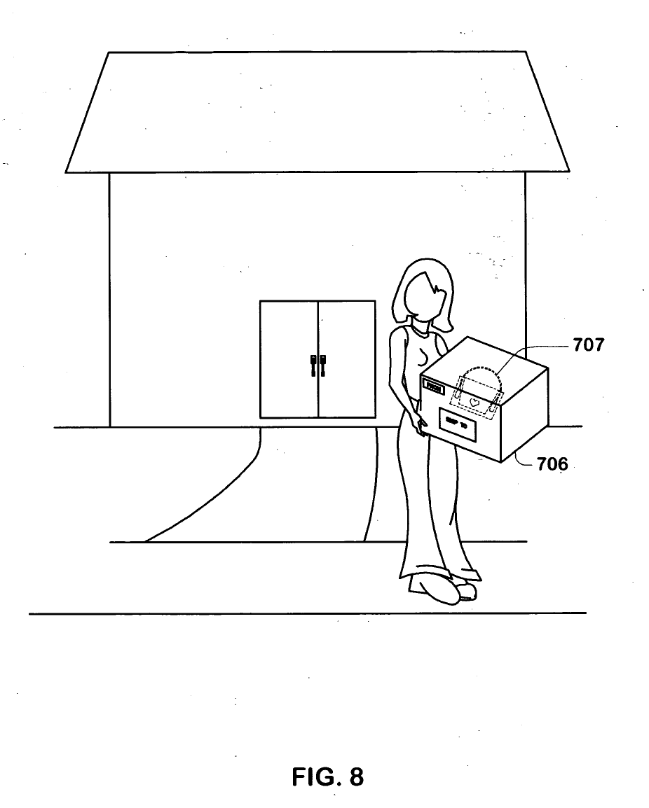

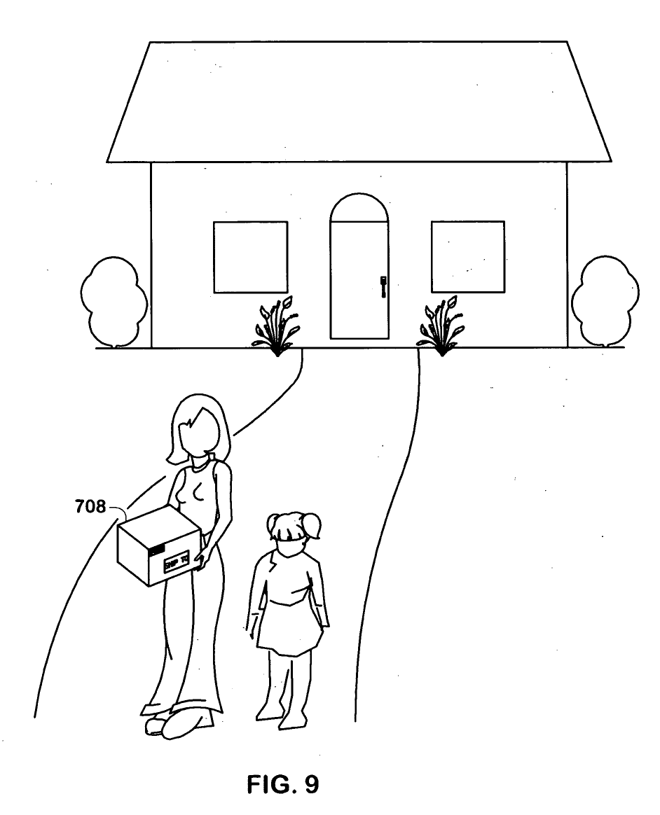

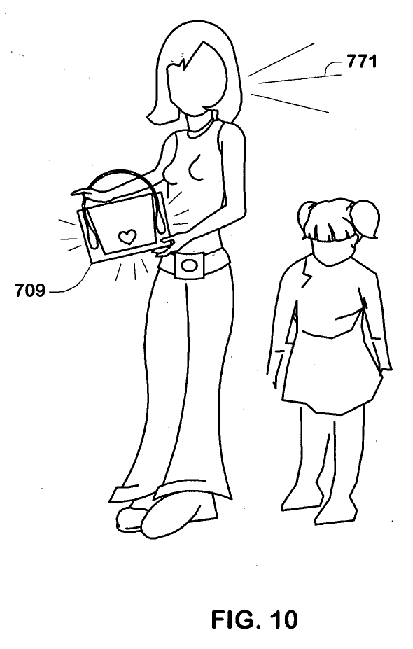

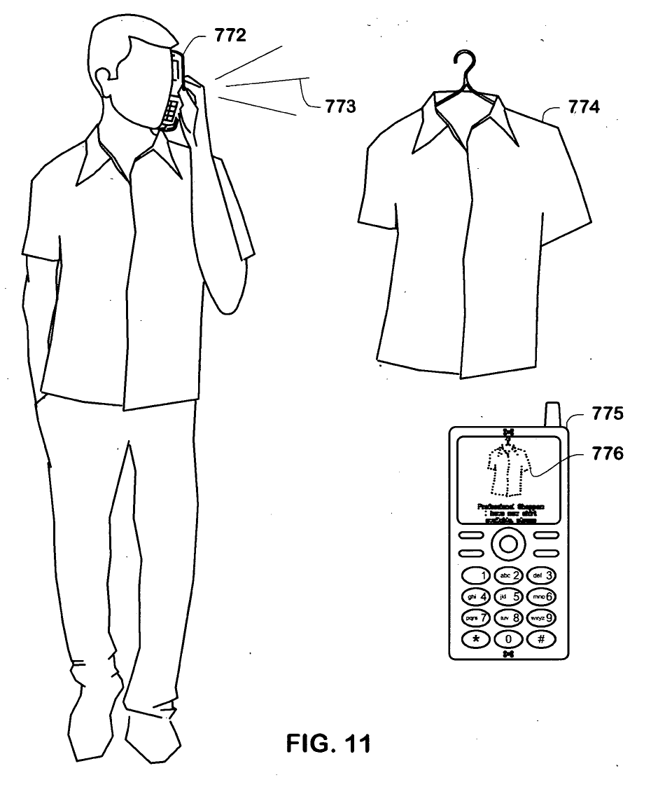

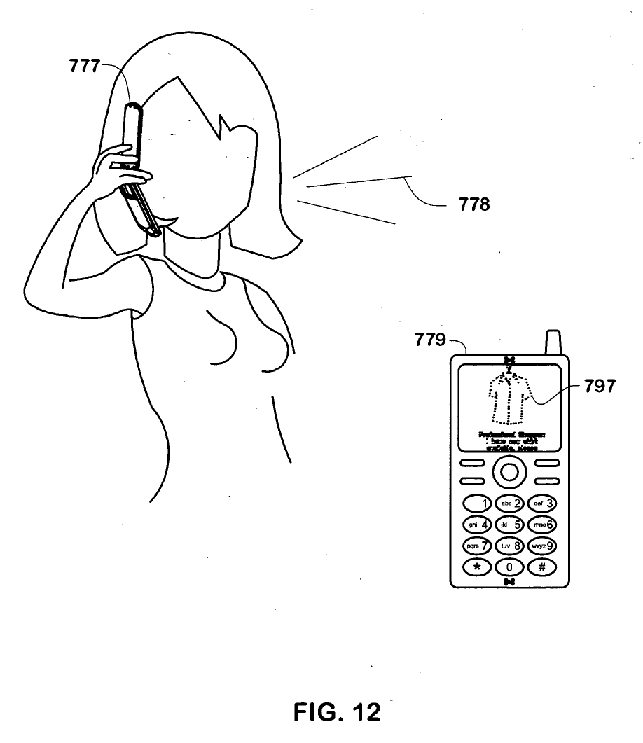

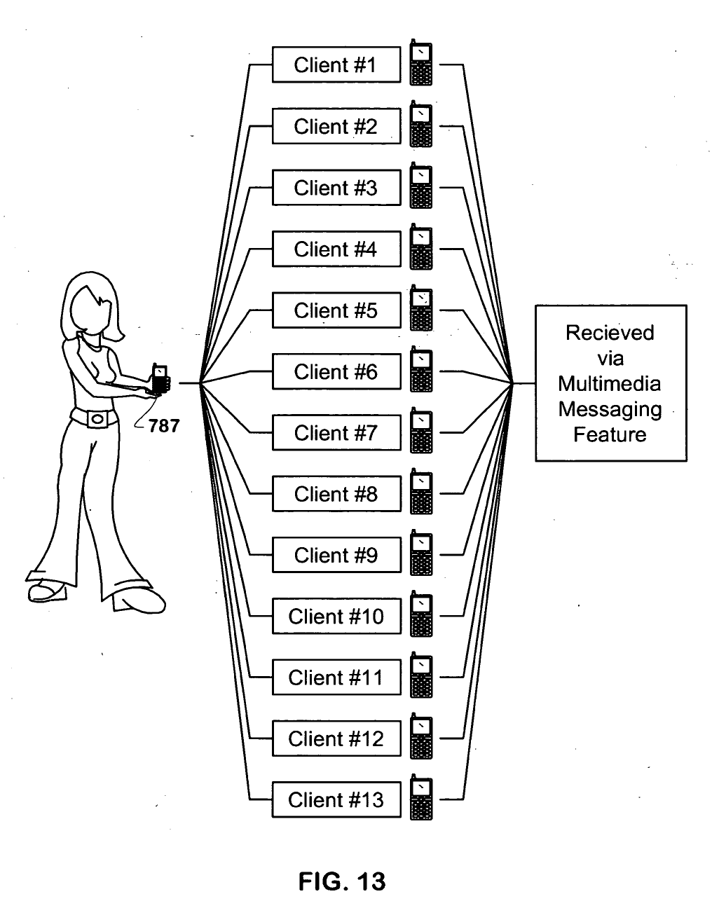

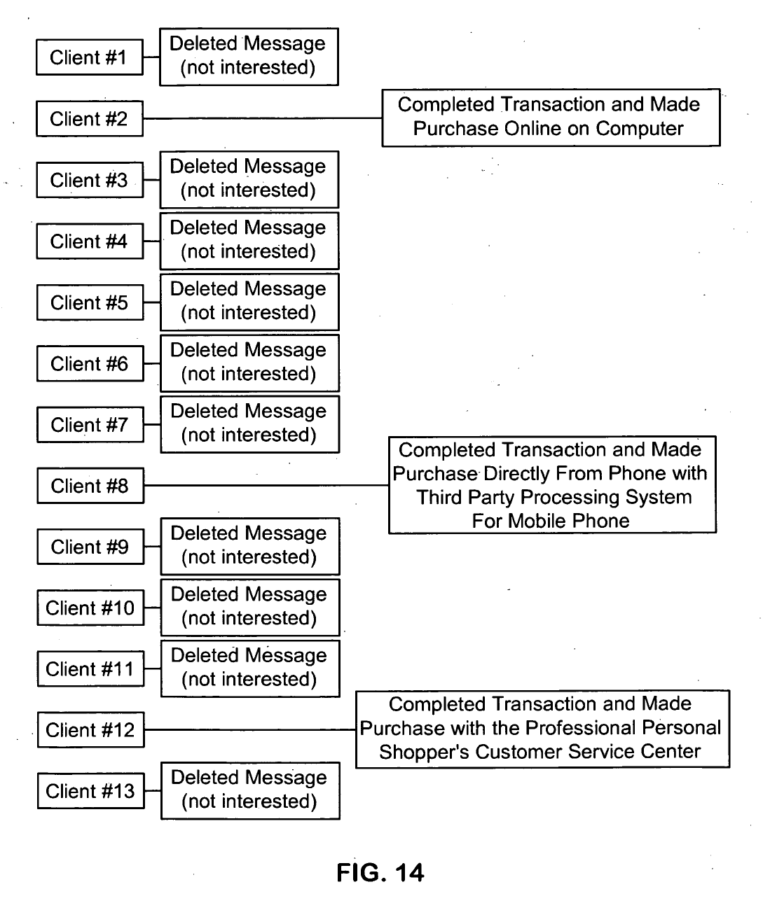

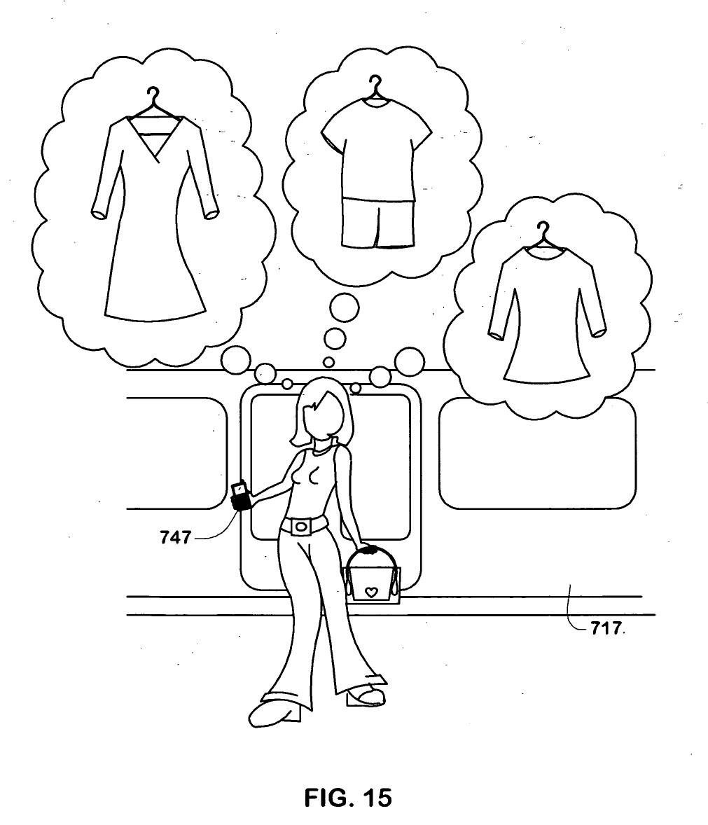

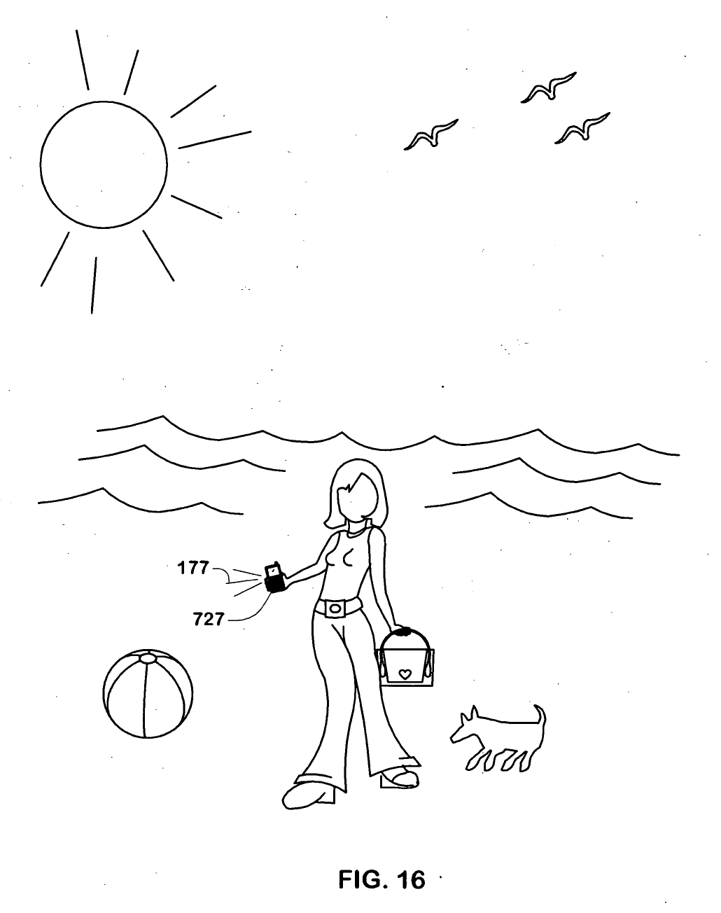

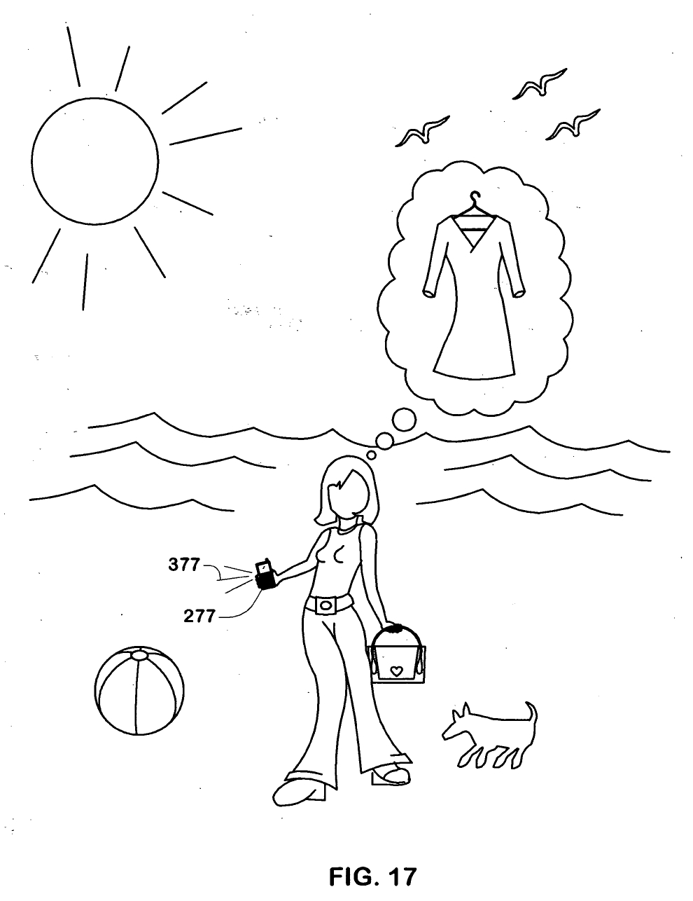

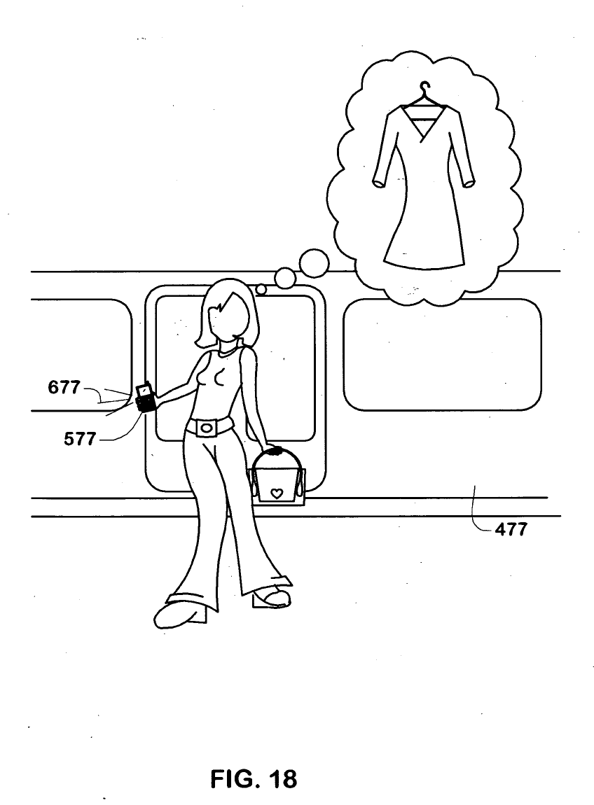

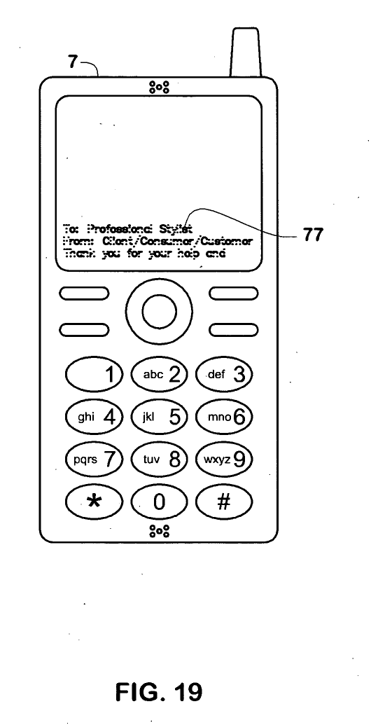

The Personal Mobile Shopping Network shopping method system comprises essentially a wireless cellular device with multimedia messaging features and a network of retailing contact members to function as a personal shopping service. FIG. 1 shows an example of how the personal shopper captures a picture of the merchandise through the shopper's mobile phone or PDA device; FIG. 2 shows an example of what will be sent out to the client/consumer who is on the list; FIG. 3 shows an example of how the client/consumer receives the information sent by the personal shopper to his/her personal mobile phone and or PDA device; FIG. 4 shows an example of the client/consumer receiving the message; FIG. 5 shows an example of how the message appears and is received by the client/consumer; FIG. 6 shows an example of the client placing an immediate order for the item through the personal shoppers 800 number that is received at an established call center; FIG. 7 shows an example of the option of consumer making the purchase from the personal shopper via the established website/shopping cart online with a computer; FIG. 8 shows an example of the Personal Shopper shipping the requested item to the consumer using one of the various existing shipping methods; FIG. 9 shows an example of the consumer/client receiving the purchased item; FIG. 10 shows an example of the consumer/client admiring a successful and easy purchase; FIG. 11 shows an example of how the picture item is issued to clients directly from the vendor/designer/retailer without the personal shopper physically capturing the image themselves. In this image a retailer multimedia messages the personal professional shopper a picture of the item, and alerts the professional shopper of the availability of the item. FIG. 12 shows an example of the personal professional shopper receiving the alert from the retailer/vendor/designer/seller, approving the item for the client list and requesting further information from the retailer/vendor/designer/seller. FIG. 13 shows a flow chart of how the multimedia message, once composed and received in its entirety is sent directly from the mobile cellular device of the professional personal shopper to the client list and received. (client list is not limited to the sample amount that is shown in the illustration. FIG. 14 shows a flow chart of consumer/client/customer behavior response to receiving the multimedia message alert of the shirt for sale. Client/customer/consumer's #2, #3, #4, #5, #6, #7, #9, #10, #11, #13 received the message, were not interested, and simply deleted the message, while client #2 purchased the item online at the company website, client #8 purchased the item directly through phone with a third party payment mobile processing company that uses the username and password of the client, and client #12, made the purchase with the professional personal shoppers customer service center (illustrative shipping and transaction acknowledgement relative the illustrated process featured in FIGS. 12, 13, and 14, can be referred back to FIGS. 7, 8, 9). FIG. 15 shows an example of a client in need of assistance of making a wardrobe choice on their way home from work, and sends a multimedia message through her mobile cellular device for advice to the professional personal shopping stylist. FIG. 16 shows an example of the professional shopper receiving the multimedia message through her mobile cellular device in another location near a beach. FIG. 17 shows an example of the professional shopper replying, with advice to the client/consumer/customers fashion concerns using the multimedia feature of her mobile cellular device. FIG. 18 shows an example of the client/consumer/customer receiving the advice from the professional shopper stylist, through the multimedia messaging option on her mobile cellular device; FIG. 19 shows an example of how the multimedia messages are viewed on the screen of the mobile cellular device when received through multimedia messaging. (this particular message does not include a picture as they do not always have to)

Customer/Client is interested in joining the shopping network to receive alerts of the items that become available for sale at the best price. The information of customer/client is then stored in the personal mobile cellular device of the professional personal shopper, and the company database for future reference. The customer/client can then begin receiving multimedia shopping message alerts.

The professional personal shopper goes out and either contacts the network of retailers/designers/distributors to find out what they have available for her client list, and/or they send the alerts to the professional personal shopper. The shopper sorts through the items for the best deals and clicks camera picture of the item with the cellular phone, additionally the image can also be provided by the retailing network member for distribution through the mobile phone in order to not limit the means of obtaining picture. The description of the item is composed with the retailing price sale price description specifications as well as the multiple purchasing transaction options, and company disclaimer, and is sent real time to the clients on file in the address book list. The message is then received for review of the clients/consumer, if they like the item they can purchase the items through the following methods, they may log on to the online store where the items are stored for clients reference, or they may contact the customer service department of the company through the established company number, or the customer can choose to complete the purchasing transaction after having registered with the third party mobile fund processing service. Once the order has been received it will be forwarded to the seller for processing and a confirmation email receipt will be sent. Item will then be shipped in accordance with the customer's desired terms. Return policies will vary according to the individual retailing seller involved with the network, but that will completely be disclosed in the initial multimedia messaging alert that is initially issued to the client/consumer.

If the client/consumer so desires, they may request an item and the personal shopping professional will seek out to find and obtain the item for the client. This potion of the services offered will likely incur a service fee as it will be considered a special order, and require additional attention.

The client/consumer will also be given the right to submit requests to the professional style shoppers through the multimedia option of their mobile cellular device for advice, and personal styling tips that may include but are not limited to wardrobe cleaning closet cleaning special, and event appearances. Depending on the consumer's personal desire, he/she can request a reply via multimedia message or request a personal consultation in accordance with their personal needs.

Ultimately, there is a potential for the owner/operator/fashion coordinator to become a personal shopper for a customer to provide a tailored, buying service for the additional needs of each individual customer, i.e. the customer can be directly marketed to in the future based on the customer's fashion desires.

Having thus described the invention in detail, it is to be understood that the foregoing description is not intended to limit the spirit and scope thereof. What is desired to be protected by Letters Patent is set forth in the appended claims.

What is claimed is:

1. A method of selling merchandise to customers comprising:
Establishing a network of clients/consumers mobile telephone numbers, and contact information to be stored in the database of the Personal Shopper;
personal Shopper comparison shops and obtains images of merchandise, and description capturing image physically and securing pictures as well as descriptions of these items from all existing or established retailing sources;
personal Shopper then creates the items description sale alert to be sent to the customer/clients device to the clients/consumers mobile cellular device through multimedia messaging as a full descriptive sale alert complete with picture, description of item, cost and purchasing options;
item description, cost, image, and the payment methods are sent to customers phones allowing customer to decide on purchase;
allowing customer to purchase merchandise the Personal Shopper has found for sale through various available transaction methods;
advice being given to customers on demand as well as tips on how to use, wear, or store merchandise through multimedia messaging through customer's mobile cellular device.

2. The method of claim 1 further comprising the step of identifying and recruiting potential clients/customers and compiling their contact information and storing it in the Personal Shoppers own database and cellular phones.

3. The method of claim 2 further comprising the step of the Personal Shopper obtaining items to be sold to customer in the network, physically from designer showrooms, online and brick and mortar retailers, manufacturers, auctions, or consignment.

4. The method of claim 3 further comprising the step of allowing a customer to view items for sale through the multimedia messaging feature on their mobile cellular device.

5. The method of claim 1 further comprising the step of allowing a customer to make purchases with a credit card.

6. The method of claim 5 further comprising the step of making suggestions to the customer about season fashion trends for the customer through the customer's multimedia option on their mobile cellular device.

7. The method of claim 6 further comprising the step of making suggestions to the customer concerning compensating or accentuating the customers body type.

8. A mobile retail clothing and accessory retailing service apparatus comprising:
mobile phone and or PDA device to capture pictures and store client contact information;
capturing pictures on demand with the camera phone;
distributing alerts to customers/clients of merchandise for sale through the multimedia messaging feature on the customer/client mobile cellular device;
the ability of the customer to store or delete desired items at their convenience through the privacy of their own phone and have items shopped for them and sent to them through the multimedia option of their cellular mobile device;
means for allowing customer to ask Personal Mobile Shopping Network for advice or request special merchandise directly to the Professional Shopper through the multimedia messaging feature on their mobile cellular device;
multiple-credit card processing service means, online website boutique for further information of items received, as well as customer service support to assist with options for client/consumers to process purchase transactions through the mobile phone, or questions.

9. The apparatus of claim 8 wherein the mobile phone has the ability to accept picture images detailed description of items and disclaimers through the phone established multimedia messaging feature.

10. The apparatus of claim 9 further comprising customer contact information is stored in the phones address book, or retrieved from alternate customer storage data base.

11. The apparatus of claim 10 wherein capturing snap picture of merchandise or transferring image directly from the web.

12. The apparatus of claim 11 further giving customer/client the option to store wanted or delete unwanted items for future reference.

13. The apparatus of claim 8 wherein mobile cellular device may be of any brand, any carrier mobile phone or PDA device with multimedia messaging capabilities.

14. The apparatus of claim 13 wherein the mobile phone has the ability to capture and store multimedia messages.
